(19) United States
(12) Patent Application Publication
(10) Pub. No.: US 2012/0128911 A1
(43) Pub. Date: May 24, 2012

(54) SOLID STATE POLYMERIZATIONS OF POLYESTER

(75) Inventor: KAZUKI AKIBA, Kennett Square, PA (US)

(73) Assignee: E. I. DU PONT DE NEMOURS AND COMPANY, Wilmington, DE (US)

(21) Appl. No.: 13/293,189

(22) Filed: Nov. 10, 2011

Related U.S. Application Data
(60) Provisional application No. 61/415,966, filed on Nov. 22, 2010.

(51) Int. Cl. B32B 1/08; C08L 77/00; C08L 33/02; C08L 67/04

(52) U.S. Cl. 428/36.9; 525/450; 525/420; 525/190

(57) ABSTRACT

Disclosed is an improved process for solid state polymerization of copolyester thermoplastic elastomers that results in a reduction of solid state polymerization reaction time while producing a high molecular weight product. The addition of 10 wt % or less of polar polymers i) having melting points at least 40° C. below the melting temperature or melting point of a copolyester thermoplastic elastomer and ii) having a solubility parameter greater than 18.4 (J/cm³)^{1/2} results in a copolyester thermoplastic elastomer composition which, after solid state polymerization, has either a melt flow rate which is less than or equal to 1/100 the melt flow rate of the copolyester thermoplastic elastomer/polar polymer blend and/or which exhibits a polymerization rate value of greater than or equal to 0.2 [ln(g/10 min.)]/hour.

### CROSS-REFERENCE TO RELATED APPLICATIONS

This application claims priority from U.S. Patent Application Ser. No. 61/415,966, filed on Nov. 22, 2010, which is incorporated herein by reference in its entirety.

### FIELD OF THE INVENTION

The present invention relates to the field of copolyester thermoplastic elastomer compositions and improved solid state polymerization of copolyester thermoplastic elastomers.

### BACKGROUND OF THE INVENTION

Copolyester thermoplastic elastomers (TPC) are typically prepared on an industrial scale in a two stage process. The first stage in TPC preparation involves the direct esterification of an acid-containing compound with a reactive compound such as a diol, or alternatively, transesterification of an ester containing compound with a reactive compound (e.g., ethylene glycol) to form a low molecular weight precondensate. In a second stage, the precondensate is polycondensed to form high molecular weight copolyester thermoplastic elastomers. Both stages typically employ catalytic acceleration.

Depending on the end use of the copolyester thermoplastic elastomer, a further solid state polymerization (SSP) step is employed to arrive at the desired viscosity or molecular weight. SSP allows for the preparation of high viscosity polymers which cannot be easily prepared in the melt or as highly viscous solutions which could require very expensive and energy intensive equipment.

As with any process, it is desirable to reduce cost of manufacture in SSP processes. One way to accomplish this goal is by reducing reaction time. Typically, in order to reduce reaction time while still reaching a targeted molecular weight, reaction rate must be increased, a common method being to increase reaction temperature. However, the reaction temperature used in SSP processes is limited by the melting temperature or melting point of the product. Increasing vacuum or nitrogen flow during a reaction can occasionally increase reaction rate by increasing the rate of elimination of reaction by-products, but this results in higher costs. Increasing surface area ratio by reducing particle size of the starting material in a SSP process is another way to increase reaction rate, but smaller particle sizes can cause feeding issues in subsequent processes in which the TPC product may be used.

U.S. Patent Application Publication 2003/0139566A1 discloses a process for increasing the polymerization rate in SPP processes by adding a catalytic amount of zinc p-toluenesulfonate to a polyester polymer melt that is essentially free of antimony and germanium.

U.S. Patent Application Publication 2009/0005531A1 discloses a process in which titanate catalysts are employed in the esterification, transesterification or polycondensation steps of a polyester manufacturing process. It is also disclosed that the presence of certain phosphinate compounds permits higher molecular weight build-up, or viscosity increase, during a subsequent SSP step.

EP335819 B1 teaches a process for preparing ultra-high molecular weight polyester resin which comprises: (1) dissolving a polyester prepolymer in a suitable organic solvent: (2) recovering the polyester prepolymer from the organic solvent to produce a porous, fibrous mass of the polyester prepolymer; and (3) solid state polymerizing the porous, fibrous mass at an elevated temperature to produce an ultra-high molecular weight polyester resin.

However, there is still a need to for novel processes which decrease the reaction time of SSP reactions without sacrificing molecular weight of the final TPC product.

### SUMMARY OF THE INVENTION

In one aspect the present invention is directed to a process for solid state polymerization of copolyester thermoplastic elastomers having i) a melt flow rate of from 20-50 g/10 minutes as determined according to ISO 1130 at 230° C. under a 2.16 kg load and ii) a melting temperature, the process comprising the steps of:
A. melt mixing
   1.90-99.5 wt % of a copolyester thermoplastic elastomer; and
   2. 0.5-10 wt % of a polar polymer having a melting temperature in the range of 40° C. to 110° C. below the melting temperature of the copolyester thermoplastic elastomer, said polar polymer having a solubility parameter of greater than or equal to 18.4 (J/cm³)^{1/2}, to provide a melt-mixed polymer blend;
   wherein the weight percentages of said copolyester thermoplastic elastomer and said polar polymer are based on the total weight of the copolyester thermoplastic elastomer and polar polymer;
B. forming solid polymer particles from the melt-mixed polymer blend;
C. heating the solid polymer particles under vacuum or an inert atmosphere to a temperature that is 5° C. to 50° C. below the melting temperature of the copolyester thermoplastic elastomer to provide heat-treated solid polymer particles comprising a copolyester resin composition, wherein the heat-treated solid polymer particles have a melt flow rate, as determined according to ISO 1130 at 230° C. under a 2.16 kg load which is less than or equal to 1/100 the melt flow rate of the melt-mixed polymer blend; and
D. cooling and collecting said heat-treated solid polymer particles.

In a second aspect, the invention is directed to a process for the solid state polymerization of copolyester thermoplastic elastomers having i) a melt flow rate as determined according to ISO 1130 at 230° C. under a 2.16 kg load of from 20-50 g/10 minutes and ii) a melting temperature, the process comprising the steps of:
A. melt mixing:
   1.90-99.5 wt % of a copolyester thermoplastic elastomer; and
   2. 0.5-10 wt % of a polar polymer having a melting temperature in the range of 40° C. to 110° C. below the melting temperature of the copolyester thermoplastic elastomer, said polar polymer having a solubility parameter of greater than or equal to 18.4 (J/cm³)^{1/2}, to provide a melt-mixed polymer blend;
   wherein the weight percentages of said copolyester thermoplastic elastomer and said polar polymer are based on the total weight of the copolyester thermoplastic elastomer and polar polymer;
B. forming solid polymer particles from the melt-mixed polymer blend;
C. heating the solid polymer particles under vacuum or an inert atmosphere to a temperature that is 5° C. to 50° C. below the melting temperature of the copolyester thermoplastic elastomer, thereby resulting in a polymerization rate of greater than or equal to 0.2 [ln(g/10 min.)]/hour to provide heat-treated solid polymer particles; and
D. cooling and collecting the heat-treated solid polymer particles.

The invention is further directed to articles comprising copolyester thermoplastic elastomers prepared by processes of the invention.

### DETAILED DESCRIPTION OF THE INVENTION

In accordance with the invention, efficiency of SSP processes for preparation of TPCs can be improved by the addition of 0.5-10 wt % of polar polymers to the TPC starting materials, where the percentage of polar polymer is based on the total weight of the TPC starting material and the polar polymer. Improved efficiency is indicated by an enhanced rate of polymerization.

The polar polymers useful in the processes of the invention have melting temperatures, sometimes referred to as melting points (mp), of from 40° C. to 110° C. lower than the melting temperature of the TPC starting materials and solubility parameters greater than 18.4 (J/cm³)^{1/2}. Melting temperatures or melting points of copolyester polymers and polar polymers useful in the practice of the invention can be determined by differential scanning calorimetry (DSC), according to ISO 11357-1/-3, generally at heating rates of 10° C./minute. Polar polymers having this combination of melting point and solubility parameter characteristics improve SSP efficiency in preparation of high molecular weight TPCs.

In carrying out the process of the invention the polar polymers may be added to a TPC by extrusion or other mixing processes. Alternatively, the polar polymers may be added at the conclusion of a liquid phase polymerization step, prior to the SSP step.

TPCs useful as starting materials in the process of the invention include copolyesterester elastomers and copolyetherester elastomers, the latter being preferred. TPCs useful in the invention preferably have melting temperatures or melting points in the range of about 160° C. to about 230° C., and more preferably about 180° C. to 230° C.

Copolyesterester elastomers are block copolymers containing a) hard polyester segments and b) soft and flexible polyester segments. Examples of hard polyester segments are polyalkylene terephthalates, poly(cyclohexanedicarboxylic acid cyclohexanemethanol). Examples of soft polyester segments are aliphatic polyesters, including polybutylene adipate, polytetramethyladipate and polycaprolactone. The copolyesterester elastomers contain blocks of ester units of a high melting polyester and blocks of ester units of a low melting polyester which are linked together through ester groups and/or urethane groups. Copolyesterester elastomers comprising urethane groups may be prepared by reacting the respective polyester starting materials in the molten phase, after which the resulting copolyesterester is reacted with a low molecular weight polyisocyanate, such as for example diphenylmethylene diisocyanate.

Copolyetherester elastomers are the preferred thermoplastic polyester starting materials for preparation of the copolyester resin compositions described herein. Copolyetherester elastomers useful in the practice of the invention have a multiplicity of recurring long-chain ester units and short-chain ester units joined head-to-tail through ester linkages, said long-chain ester units being represented by formula (A):

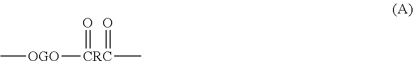

and said short-chain ester units being represented by formula (B):

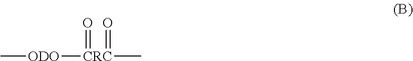

wherein
G is a divalent radical remaining after the removal of terminal hydroxyl groups from poly(alkylene oxide)glycols having a number average molecular weight of between about 400 and about 6000, or preferably between about 400 and about 3000;
R is a divalent radical remaining after removal of carboxyl groups from a dicarboxylic acid having a molecular weight of less than about 300;
D is a divalent radical remaining after removal of hydroxyl groups from a diol having a molecular weight less than about 250.

As used herein, the term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxyl groups and having a number average molecular weight of from about 400 to about 6000, and preferably from about 600 to about 3000. Preferred poly(alkylene oxide) glycols include poly(tetramethylene oxide) glycol, poly(trimethylene oxide) glycol, poly(propylene oxide) glycol, poly(ethylene oxide) glycol, copolymer glycols of these alkylene oxides, and block copolymers such as ethylene oxide-capped poly(propylene oxide) glycol. Mixtures of two or more of these glycols can be used.

As used herein, the term “short-chain ester units” as applied to units in a polymer chain of the copolyetheresters refers to low molecular weight compounds or polymer chain units having molecular weights less than about 550.

These materials are made by reacting a low molecular weight diol or a mixture of diols (molecular weight below about 250) with a dicarboxylic acid to form ester units represented by Formula (B) above. Included among the low molecular weight diols which react to form short-chain ester units suitable for use in preparing copolyetheresters are acyclic, alicyclic and aromatic dihydroxy compounds. Preferred compounds are diols with about 2-15 carbon atom such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, etc. Especially preferred diols are aliphatic diols containing 2-8 carbon atoms, and a more preferred diol is 1,4-butanediol. Included among the bisphenols which can be used are bis(p-hydroxy)diphenyl, bis(p-hydroxyphenyl)methane, and bis(p-hydroxyphenyl)propane. Equivalent ester-forming derivatives of diols are also useful. As used herein, the term “diols” includes equivalent ester-forming derivatives. However, any molecular weight requirements refer to the corresponding diols, not their derivatives.

Dicarboxylic acids that can react with the foregoing long-chain glycols and low molecular weight diols to produce the copolyetheresters are aliphatic, cycloaliphatic or aromatic dicarboxylic acids of a low molecular weight, i.e., having a molecular weight of less than about 300. The term “dicarboxylic acids” as used herein includes functional equivalents of dicarboxylic acids that have two carboxyl functional groups that perform substantially like dicarboxylic acids in reaction with glycols and diols in forming copolyetherester polymers. These equivalents include esters and ester-forming derivatives such as acid halides and anhydrides. The molecular weight requirement pertains to the acid and not to its equivalent ester or ester-forming derivative.

Thus, an ester of a dicarboxylic acid having a molecular weight greater than 300 or a functional equivalent of a dicarboxylic acid having a molecular weight greater than 300 are included, provided the corresponding acid has a molecular weight below about 300. The dicarboxylic acids can contain any substituent group(s) or combination that does not substantially interfere with copolyetherester polymer formation and/or use of the polymer in the compositions of the invention.

As used herein, the term “aliphatic dicarboxylic acids” refers to carboxylic acids having two carboxyl groups each attached to a saturated carbon atom. If the carbon atom to which the carboxyl group is attached is saturated and is in a ring, the acid is cycloaliphatic. Aliphatic or cycloaliphatic acids having conjugated unsaturation often cannot be used because homopolymerization results. However, some unsaturated acids, such as maleic acid, can be used.

As used herein, the term “aromatic dicarboxylic acids” refers to dicarboxylic acids having two carboxyl groups each attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—. Representative useful aliphatic and cycloaliphatic acids that can be used include sebacic acid; 1,3-cyclohexane dicarboxylic acid; 1,4-cyclohexane dicarboxylic acid; adipic acid; glutaric acid; 4-cyclohexane-1,2-dicarboxylic acid; 2-ethylsuberic acid; cyclopentanedicarboxylic acid, decahydro-1,5-naphthylene dicarboxylic acid; 4,4′-bicyclohexyl dicarboxylic acid; decahydro-2,6-naphthylene dicarboxylic acid; 4,4′-methylenebis(cyclohexyl)carboxylic acid; and 3,4-furan dicarboxylic acid. Preferred acids are cyclohexane dicarboxylic acids and adipic acid.

Representative aromatic dicarboxylic acids include phthalic, terephthalic and isophthalic acids; bibenzoic acid; substituted dicarboxyl compounds with two benzene nuclei such as bis(p-carboxyphenyl)methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C₁-C₁₂ alkyl and ring substitution derivatives thereof, such as halo, alkoxy, and aryl derivatives. Hydroxy acids such as p-(beta-hydroxyethoxy)benzoic acid can also be used provided an aromatic dicarboxylic acid is also used.

Aromatic dicarboxylic acids are a preferred class for preparing the copolyetherester elastomers useful for this invention. Among the aromatic acids, those with 8-16 carbon atoms are preferred, particularly terephthalic acid alone or in a mixture of phthalic and/or isophthalic acids.

The copolyetherester elastomer preferably comprises from at or about 15 to at or about 99 weight percent short-chain ester units corresponding to Formula (B) above, the remainder being long-chain ester units corresponding to Formula (A) above. More preferably, the copolyetherester elastomer comprises from at or about 20 to at or about 95 weight percent, and even more preferably from at or about 50 to at or about 90 weight percent short-chain ester units, where the remainder comprises long-chain ester units. More preferably, at least about 70% of the groups represented by R in Formulae (A) and (B) above are 1,4-phenylene radicals and at least about 70% of the groups represented by D in Formula (B) above are 1,4-butylene radicals and the sum of the percentages of R groups which are not 1,4-phenylene radicals and D groups that are not 1,4-butylene radicals does not exceed 30%. If a second dicarboxylic acid is used to prepare the copolyetherester, isophthalic acid is preferred and if a second low molecular weight diol is used, ethylene glycol, 1,3-propanediol, cyclohexanedimethanol, or hexamethylene glycol are preferred.

A blend or mixture of two or more copolyetherester elastomers can be used in the practice of the invention. The copolyetherester elastomers used in the mixture need not on an individual basis come within the values disclosed herein for the elastomers. However, the blend of two or more copolyetherester elastomers must conform to the values described herein for the copolyetheresters on a weighted average basis. For example, in a mixture that contains equal amounts of two copolyetherester elastomers, one copolyetherester elastomer can contain 60 weight percent short-chain ester units and the other resin can contain 30 weight percent short-chain ester units for a weighted average of 45 weight percent short-chain ester units.

Preferred copolyetherester elastomers include, but are not limited to, copolyetherester elastomers prepared from monomers comprising (1) poly(tetramethylene oxide) glycol; (2) a dicarboxylic acid selected from isophthalic acid, terephthalic acid and mixtures of these; and (3) a diol selected from 1,4-butanediol, 1,3-propanediol and mixtures of these, or from monomers comprising (1) poly(trimethylene oxide) glycol; (2) a dicarboxylic acid selected from isophthalic acid, terephthalic acid and mixtures of these; and (3) a diol selected from 1,4-butanediol, 1,3-propanediol and mixtures of these, or from monomers comprising (1) ethylene oxide-capped polypropylene oxide) glycol; (2) dicarboxylic acid selected from isophthalic acid, terephthalic acid and mixtures of these; and (3) a diol selected from 1,4-butanediol, 1,3-propanediol and mixtures of these.

Preferably, the copolyetherester elastomers described herein are made from esters or mixtures of esters of terephthalic acid and/or isophthalic acid, 1,4-butanediol and poly(tetramethylene ether)glycol or poly(trimethylene ether) glycol or ethylene oxide-capped polypropylene oxide glycol, or are prepared from esters of terephthalic acid, e.g. dimethylterephthalate, 1,4-butanediol and poly(ethylene oxide)glycol. More preferably, the copolyetheresters are prepared from esters of terephthalic acid, e.g. dimethylterephthalate, 1,4-butanediol and poly(tetramethylene ether)glycol.

Examples of suitable copolyetherester elastomers are commercially available under the trademark Hytrel® from E. I. du Pont de Nemours and Company, Wilmington, Del.

The TPC used as the starting material for the SSP processes of this invention can be prepared by methods known in the art. For example, one method for preparing a TPC used as the starting material for the SSP reaction is a two step process. In the first step, an esterification or transesterification step is performed by mixing together one or more dicarboxylic acids or dicarboxylic diesters with one or more diols or polyols at temperatures in the range of about 150° C. to about 300° C. and at pressures of from up to 60 psig to atmospheric to about 0.2 mm Hg. The product of this step is a low molecular weight precondensate.

In the second step, polycondensation is effected by increasing the temperature and lowering the pressure while excess diol or polyol is removed. The product is a high molecular weight TPC.

When the polycondensation (polymerization) process of the second step is completed, the resulting TPC, which is in the form of a melt, is generally filtered and is typically extruded, quenched, for example in a water trough or alternative cooling unit, and then pelletized. The thus-produced cooled pellets may be used as the TPC starting material which is mixed with a polar polymer according to the processes of the invention.

However, in another aspect of the invention, the TPC from the polycondensation step (second step), while still in melt form, is immediately melt mixed with the polar polymer to provide a polymer mixture that is extruded, quenched in a water trough or alternative cooling unit, and then pelletized to form solid polymer particles. The solid polymer particles are then further reacted in a SSP process.

TPCs suitable as starting polymers for the SSP processes of this invention can also be prepared by other methods well known in the art. Such methods are disclosed for example in U.S. Pat. Nos. 7,144,614; 7,132,383; 5,744,571; 6,013,756; 5,453,479; and 7,205,379. The disclosures thereof are incorporated herein by reference.

For purposes of this invention, “polar polymer” is defined as a polymer containing at least one atom selected from nitrogen, oxygen, or halogen atoms,

wherein the polymer has a weight average molecular weight (M_{w}) of at least 1000, as determined by gel permeation chromatography. Certain embodiments include polar polymers having M_{w} of at least 2000, and at least 5000. Additionally, the polar polymers useful in the invention have melting temperatures or melting points of from 40° C. to 110° C. lower than the melting temperature or melting point of the TPC starting material; and a solubility parameter greater than or equal to 18.4 (J/cm³)^{1/2}. Preferably the polar polymers have melting temperatures or melting points of from 50° C. to 90° C. lower than the melting temperature or melting point of the TPC starting material.

Polar polymers suitable for use in the processes of this invention include those selected from the group consisting of: polyamide polymers having melting temperatures or melting points of less than 210° C., preferably less than 195° C.; copolyester thermoplastic elastomers having melting temperatures or melting points of less than 200° C., preferably less than 195° C.; polyester polymers having melting temperatures or melting points of less than 200° C., preferably less than 195° C.; polylactic acid; polyacetals; polyvinylidene chloride; amorphous polymers having a glass transition point of less than 200° C., preferably less than 180° C. selected from the group consisting of polyacrylonitriles, polycarbonates, and acrylonitrile/butadiene/styrene copolymer (ABS); ethylene copolymers having melting temperatures or melting points of less than 160° C., preferably less than 145° C.; and acrylic resins.

Polyamide polymers having melting temperatures or melting points of less than 200° C. are referred to as Group (I) Polyamides, and include aliphatic or semiaromatic polyamides selected from the group consisting of poly(pentamethylene decanediamide) (PA510), poly(pentamethylene dodecanediamide) (PA512), poly(ε-caprolactam/hexamethylene hexanediamide) (PA6/66), poly(ε-caprolactam/hexamethylene decanediamide) (PA6/610), poly(ε-caprolactam/hexamethylene dodecanediamide) (PA6/612), poly(hexamethylene tridecanediamide) (PA613), poly(hexamethylene pentadecanediamide) (PA615), poly(ε-caprolactam/tetramethylene terephthalamide) (PA6/4T), poly(ε-caprolactam/hexamethylene terephthalamide) (PA6/6T), poly(ε-caprolactam/decamethylene terephthalamide) (PA6/10T), poly(ε-caprolactam/dodecamethylene terephthalamide) (PA6/12T), poly(hexamethylene decanediamide/hexamethylene terephthalamide) (PA610/6T), poly(hexamethylene dodecanediamide/hexamethylene terephthalamide) (PA612/6T), poly(hexamethylene tetradecanediamide/hexamethylene terephthalamide) (PA614/6T), poly(ε-caprolactam/hexamethylene isophthalamide/hexamethylene terephthalamide) (PA6/6I/6T), poly(ε-caprolactam/hexamethylene hexanediamide/hexamethylene decanediamide) (PA6/66/610), poly(ε-caprolactam/hexamethylene hexanediamide/hexamethylene dodecanediamide) (PA6/66/612), poly(ε-caprolactam/hexamethylene hexanediamide/hexamethylene decanediamide/hexamethylene dodecanediamide) (PA6/66/610/612), poly(2-methylpentamethylene hexanediamide/hexamethylene hexanediamide/hexamethylene terephthamide) (PA D6/66/6T), poly(2-methylpentamethylene hexanediamide/hexamethylene hexanediamide/) (PA D6/66), poly(decamethylene decanediamide) (PA1010), poly(decamethylene dodecanediamide) (PA1012), poly(decamethylene decanediamide/decamethylene terephthalamide) (PA1010/10T) poly(decamethylene decanediamide/dodecamethylene decanediamide/decamethylene terephthalamide/dodecamethylene terephthalamide (PA1010/1210/10T/12T), poly(11-aminoundecanamide) (PA11), poly(11-aminoundecanamide/tetramethylene terephthalamide) (PA11/4T), poly(11-aminoundecanamide/hexamethylene terephthalamide) (PA11/6T), poly(11-aminoundecanamide/decamethylene terephthalamide) (PA11/10T), poly(11-aminoundecanamide/dodecamethylene terephthalamide) (PA11/12T), poly(12-aminododecanamide) (PA12), poly(12-aminododecanamide/tetramethylene terephthalamide) (PA12/4T), poly(12-aminododecanamide/hexamethylene terephthalamide) (PA12/6T), poly(12-aminododecanamide/decamethylene terephthalamide) (PA12/10T) poly(dodecamethylene dodecanediamide) (PA1212), and poly(dodecamethylene dodecanediamide/dodecamethylene dodecanediamide/dodecamethylene terephthalamide)) (PA1212/12T).

Preferred Group I polyamides are selected from the group consisting of poly(ε-caprolactam/hexamethylene isophthalamide/hexamethylene terephthalamide) (PA6/6I/6T), poly(ε-caprolactam/hexamethylene hexanediamide/hexamethylene decanediamide) (PA6/66/610), poly(ε-caprolactam/hexamethylene hexanediamide/hexamethylene dodecanediamide) (PA6/66/612), poly(ε-caprolactam/hexamethylene hexanediamide/hexamethylene decanediamide/hexamethylene dodecanediamide) (PA6/66/610/612), poly(11-aminoundecanamide) (PA11), and poly(12-amino do decanamide) (PA12).

Copolyester thermoplastic elastomers having melting temperatures or melting points of less than 200° C. include poly(butylene terephthalate)/poly(alkylene ether glycol) copolymers having poly(alkylene ether glycol) contents of more than 40 wt %, poly(butyleneterephthalate/isophthalate)/poly(alkylene ether glycol) copolymers having poly(alkylene ether glycol) contents of more than 40 wt %, poly(butylene terephthalate)/poly(aliphatic polyester glycol) copolymers having poly(aliphatic polyester glycol) contents of more than 40 wt %, poly(butyleneterephthalate/isophthalate)/poly(aliphatic polyester glycol) copolymers having poly(aliphatic polyester glycol) contents of more than 40 wt %,

Polyester polymers having melting points of less than 200° C. include aliphatic or semiaromatic polyesters selected from the group consisting of poly(butylene terephthalate/isopthalate) copolymers, poly(ethylene terephthalate/isophthalate) copolymers, poly(butylene terephthalate/sebacate) copolymers, poly(ethylene terephthalate/sebacate) copolymers, and poly(butylene terephthalate/C36-dimerate) copolymers.

As used herein the term ethylene copolymers includes ethylene dipolymers, ethylene terpolymers and higher order ethylene copolymers, i.e. polymers having copolymerized units of ethylene and more than two additional different comonomers. Ethylene copolymers having melting temperatures or melting points of less than 160° C. include, but are not limited to, those selected from the group consisting of an ethylene copolymers of the formula E/X/Y wherein:
E is the radical formed from ethylene;
X is selected from the group consisting of radicals formed from

CH₂═CH(R¹)—C(O)—OR²
wherein R¹ is H, CH₃ or C₂H₅, and R² is an alkyl group having 1-8 carbon atoms; vinyl acetate; and mixtures thereof; wherein X comprises 0 to 50 weight % of the E/X/Y copolymer; and
Y is one or more radicals formed from monomers selected from the group consisting of carbon monoxide, sulfur dioxide, acrylonitrile, maleic anhydride, maleic acid diesters, (meth)acrylic acid, maleic acid, maleic acid monoesters, itaconic acid, fumaric acid, fumaric acid monoesters and potassium, sodium and zinc salts of said preceding acids, glycidyl acrylate, glycidyl methacrylate, and glycidyl vinyl ether: wherein Y is from 0.5 to 35 weight % of the E/X/Y copolymer, and preferably 0.5-20 weight percent of the E/X/Y copolymer, and the weight percentage of E present in the copolymer is the remainder in weight percent and preferably comprises 40-90 weight percent of the E/X/Y copolymer.

As used herein the terms “acrylic resin”, “(meth)acrylic resins”, and “acrylic polymers” are synonymous unless specifically defined otherwise. These terms refer to the general class of addition polymers derived from the conventional polymerization of ethylenically unsaturated monomers derived from methacrylic and acrylic acids and alkyl and substituted-alkyl esters thereof. The terms encompass homopolymers and copolymers. Acrylic resins specifically encompass the homopolymers and copolymers of monomers selected from the group consisting of methyl (meth)acrylate, ethyl (meth)acrylate, butyl (meth)acrylate, 2-hydroxyethyl (meth)acrylate, (meth)acrylic acid and glycidyl (meth)acrylate. The term copolymer, as applied herein to acrylic resins, encompasses polymers derived from polymerization of two or more monomers, unless specifically defined otherwise. The term (meth)acrylic acid encompasses both methacrylic acid and acrylic acid. The term (meth)acrylate, encompasses methacrylate and acrylate.

The polar polymers suitable for use in the process of the invention have specific solubility parameter characteristics. The solubility parameter (δ) of a material provides a numerical estimate of the degree of interaction between materials, and can be a good indication of solubility between materials. Materials with similar solubility values are likely to be miscible. The principal utility of solubility parameters is in providing simple predictions of phase equilibria that are based on a single parameter that is readily obtained for most materials. Chapter 16 in “Physical Properties of Polymers Handbook”, Second Edition, by James E. Mark (2007) contains a list of the solubility parameters of various monomers and polymeric materials.

For purposes of this invention, “solubility parameter” is defined as the square root of the cohesive energy density.

For purposes of this invention, “cohesive energy density” is defined as the cohesive energy (E_{coh}) of each repeating unit of the polymer divided by the molar volume (V) of each repeating unit of the polymer.

The solubility parameter (δ) of polymers is calculated as the square root of the cohesive energy density.

Equation (1) below may be used for calculating solubility parameters of the invention.

δ=(E_{coh}/V)^{1/2} (Eq. 1)
Where E_{coh} is cohesive energy and V is molar volume

Cohesive energy density is calculated by dividing the cohesive energy (E_{coh} J/mol) of each repeating unit of polymer by the molar volume (V cm³/mol) of each repeating unit of the polymer. Cohesive energy of each repeating unit, Ecoh, is calculated by determining the cohesive energy value of each group contained in the polymer repeating unit, multiplying the cohesive energy value of each such group by the number of instances it appears in the repeating unit of the polymer and thereby obtaining a group total cohesive energy value. The cohesive energy value may be added together to obtain the total cohesive energy value of the repeating unit. The group total molar volume of each repeating unit is calculated in the same manner as group total cohesive energy. The total cohesive energy value of the repeating unit is then divided by the total molar volume of each repeating unit to obtain the cohesive energy density. The square root of the cohesive energy density is the calculated solubility parameter of the polymer.

The following is an example of a solubility parameter calculation for nylon 6 (polyamide 6). Nylon 6 has a repeating unit of —C(O)—N(H)—(CH₂)₅—. Table 1 shows the cohesive energy and molar volume values for each group along with the quantity of each group in the repeating unit and the cohesive energy and molar volume values for the repeating unit.

TABLE 1

| | # | | V | Group | |
|---|---|---|---|---|---|
| | repeating | E_{coh} | (cm³/ | Total | Group Total |
| Group | units | (J/mol) | mol) | E_{coh (J/mol)} | V (cm³/mol) |
| —C(O)—N(H)— | 1 | 60760 | 24.9 | 60760 | 24.9 |
| —CH₂— | 5 | 4150 | 15.85 | 20750 | 79.25 |
| Totals | | | | 81510 | 104.15 |

The calculated solubility parameter is equal to (81510/104.15)^{1/2} or 27.975 (J/cm³)^{1/2}. To convert this value to units of cal/cm³ the following equation may be used:

δ(J/cm³)^{1/2}=2.0455δ(cal/cm³)^{1/2}

The solubility parameter 27.975 (J/cm³)^{1/2} is thus equivalent to a solubility parameter of 13.673(cal/cm³)^{1/2}.

Molar volume values and cohesive energy values can be found in many sources such as for example, without limitation a textbooks, treatises, technical presentations, patents, journal articles, internet articles, or other sources. Reported cohesive energy values for a group can vary depending on the source from which the value is obtained. Although molar volumes from any source may be used to calculate the solubility parameters described herein, preferred reliable data may often be found in “Properties of Polymers” by D. W. van Krevelen and K. to Nijenhuis, fourth edition, 2009. Molar volume values and cohesive energy values for use in calculating solubility parameters may be obtained experimentally by the methods described in “CRC Handbook of Polymer-liquid Interaction Parameters and Solubility Parameters” by Allan F. M. Barton, CRC Press, 1990.

In the practice of the process of the invention, the TPC starting material and the polar polymer can be melt-mixed (i.e. a shear stress is applied to the molten mixture) in for example either batch or continuous fashion. Examples of equipment used for melt mixing include, without limitation, kneaders (e.g. a Buss Co-Kneader from Buss A G, Pratteln, Switzerland), extruders (single screw, twin-screw or multi-screw), Banbury® Mixers, Farrel® Continuous Mixers (Banbury® and Farrel® are registered trademarks of Farrel Corporation, Ansonia, Conn., USA), and the like. Twin-screw extruders, such as ZSK machines from Werner & Pfleiderer (now part of Coperion Werner & Pfleiderer GmbH & Co. KG, Stuttgart, Germany) are commonly used. The optimum mixing intensity depends on a number of factors, including the configuration of the mixer, mixing temperature, and composition of the materials being mixed. Such parameters are readily determined by one skilled in the art.

In one embodiment, two or more extruders in series can be employed, each to perform one or more melt-mixing steps. Alternatively, some or all of the output of an extruder can be re-fed one or more times through the same extruder to produce the final melt-mixed composition.

After the desired degree of mixing has taken place, the melt-mixed polymer blend comprising TPC and polar polymer(s) is cooled and typically pelletized or cooled to form beads or other solid polymer particles. The solid polymer particles are then suitable for use in the SSP step of the processes of the invention.

If the crystallinity of the solid polymer particles is not sufficiently high or if the solid polymer particles are amorphous in nature, the solid polymer particles may be subjected to a crystallization operation at elevated temperatures to produce a less sticky product. Such products are more easily processed during subsequent steps that are conducted at typical SSP temperatures. The crystallizer typically operates between 150° C. to 300° C., although some processes employ higher or lower temperatures. The crystallized solid polymer particles are then introduced into the solid state polymerization reactor.

The physical shape or form of the TPC solid polymer particles to be used in the SSP processes of the invention may be that of pellets, rods, chips, beads, granules, or the like, although pellets or beads are preferred.

In the SSP step of the processes of the invention, the solid TPC solid polymer particles are subjected to high temperatures and/or low pressure conditions to effect a further increase in molecular weight and viscosity.

The solid state polymerization step may be conducted, for example, as taught in U.S. Pat. Nos. 6,160,085 and 7,205,379 and in U.S. Published Patent Application No. 2005/272906, the contents of which are hereby incorporated by reference.

The SSP step of the processes of the invention may be carried out in any reaction vessel adapted for contacting a stream of an inert gas with the solid that is undergoing solid state polymerization and removal of the by-products of solid state polymerization.

The SSP process may be carried out in either a batch or continuous mode. In one embodiment of the present invention, the SSP reactor is configured as a fixed bed with an inert gas passing through it.

An additional modification useful in carrying out the SSP processes of the invention is taught in U.S. Pat. No. 7,179,881, the contents of which are incorporated herein by reference. This patent discloses that heat recovered from SSP pellets may be used to heat polymer pellets prior to entry into the SSP reactor. As disclosed in U.S. Pat. No. 6,960,641, the teaching of which is incorporated herein by reference, block copolymers may be prepared by SSP. Such polymers may be prepared using the processes of the present invention wherein a polar polymer is used to increase polymerization efficiency.

Temperature control of the SSP process is critical. If the reaction temperature of the SSP step (i.e. the heat-treating step) of the process of the present invention is too low, the polymerization reaction will be extremely slow, while if the reaction temperature of the SSP step of the process is too high, the solid polymer particles will melt or soften, thereby forming clumps which can clog or jam feeders or other components of the processing equipment.

The SSP reaction that takes place in the heat-treating step of the process of the invention is typically carried out at temperatures of from about 150° C. to about 300° C., depending upon the melting temperature or melting point of the particular polymer. If the SSP temperature is too low, the SSP step is not very efficient. If the SSP temperature is too high, the solid polymer particles either melt or become soft. This results in adhesion of the solid polymer particles to each other or to the interior walls of the reaction vessel. The temperature differential between the solid polymer particle melting temperature or melting point and the SSP reaction temperature can be as small as 5° C., if the solid polymer particles do not adhere to each other or to the interior walls of an SSP vessel. The SSP reaction temperature can be set from 5° C. to 50° C., preferably from 5° C. to 30° C., below the melting point of the TPC in order to avoid adhesion of the solid polymer particles.

The SSP reaction can be conducted under a vacuum of from about 0.1 ton to about 5 torr, preferably from about 0.1 ton to about 1 ton, to promote removal of reaction by-products. The temperature, pressure and reaction time may be suitably selected so that heat-treated solid polymer particles having a specific molecular weight will be formed.

The SSP reaction may be conducted for periods ranging from 1-100 hours, but it is typically conducted over a period of 24 hours.

Alternatively, the SSP step of the process of the invention may be performed in an inert atmosphere or under a continuous flow of an inert gas such as nitrogen, argon helium, carbon dioxide, a hydrocarbon gas. In another embodiment, the SSP step may be conducted in an atmosphere swept by a continuous flow of a vaporized carrier gas compound that is a poor solvent for the polymeric reactants and products. The carrier gas is preferably introduced into the reaction system after the reaction mixture has been heated to a temperature that is near the final reaction temperature, for example within 5° C. of the reaction temperature.

Examples of poor solvents are straight-chain or branched-chain saturated hydrocarbons having from 4 to 18 carbon atoms or a hydrocarbon having a low degree of unsaturation and having from 4 to 18 carbon atoms and which is inert to the reactants. A boiling point exceeding 250° C. is not preferred because the removal of the solvent from the solid particles becomes difficult.

The heat-treating step, i.e. the SSP step, of the process of the invention is preferably conducted under conditions which promote uniform polymerization and efficiency. It is preferred to agitate the solid polymer particles to cause them to flow, for example by stirring them, rotating the reactor, or blowing a heated gas through the particles. The solid polymer particles can also be tumbled using tumbling equipment known in the art. Typically, tumbling is preferred when the reactor temperature is less than 25° C. below the melting temperature or melting point of the solid polymer particles. Tumbling prevents the solid polymer particles from adhering to each other and thereby forming a solid mass which could cause reactor shut-down. An example of a tumbling reactor is a double cone rotary reactor.

The SSP reaction can optionally be conducted under reduced pressure in combination with the use of an inert gas atmosphere or in combination with the use of an inert gas carrier.

The catalyst used in the solid state polymerization step of the process of the invention is preferably the catalyst remaining after production of the TPC prepolymer or TPC precondensate that is used to form the TPC starting material. Alternatively, the catalyst may be freshly added to the polymer particles used in the SSP step of the process of the invention. As such, the catalyst may be in the form of powder, liquid or gas. Any catalyst typically used in the melt preparation of the TPC starting material can be used in the SSP step of the process. Non-limiting examples of catalysts include tetrabutyl titanate, used alone or in combination with magnesium or calcium acetates, and complex titanates such as Mg[HTi(OR₄)]₂ derived from alkali or alkali earth metal alkoxide and titanate esters.

Once the desired reaction temperature for the SSP reaction is reached, the solid polymer particles are heated for a sufficient period of time (reaction time) that the target melt flow rate of the resin product is obtained. Melt flow rate is determined according to ISO 1130 at 230° C. under a 2.16 kg load. During the SSP reaction, the temperature during the heating period is at least 5° C. to 50° C., preferably 5° C. to 30° C., below the melting temperature or melting point of the solid polymer particles to prevent the solid polymer particles from adhering to each other or to the reaction vessel wall. For example, if the melting temperature or melting point of the solid polymer particles is 200° C., then the desired reaction temperature is 195° C. or lower, such as 190° C.

The reaction temperature and the reaction time of the solid state polymerization step of the process of the invention vary depending upon the type (for example, chemical structure, molecular weight) and shape of the solid polymer particles, the type and amount of the catalyst remaining in the solid polymer particles, the type and amount of the supplemental catalyst added, the degree of crystallization and melting temperature of the solid polymer particles, the required polymerization degree of the heat-treated solid polymer particles, and other reaction conditions. The SSP step is preferably carried out at a temperature which is not lower than the glass transition temperature of the TPC and allows the TPC polymer mixture to be maintained in a solid state without melting during the SSP step.

Once the SSP heating period of the reaction is complete, the solid particles of the polyester resin composition product are cooled and collected. Any known method for cooling the solid particles can be used. An example of a method for cooling solid particles is described in U.S. Pat. No. 7,217,782 B2 which is incorporated herein by reference. The solid particle particles can also be cooled by using a gas which flows through the particles and removes residual heat from the particles. This process can be accomplished while the solid polymer particles are tumbled or while the particles are static or not moving.

The heat-treated solid polymer particles from the SSP step of the invention are very high molecular weight polymers (i.e. they have a very low melt flow rate as determined according to ISO 1130 at 230° C. under a 2.16 kg load). The heat-treated solid polymer particles from the SSP step of the process typically have a melt flow rate (MFR) less than 1 g/10 minutes, preferably less than 0.5 g/10 minutes. The heat-treated solid polymer particles prepared in the SSP reaction of the process of the invention have a final MFR which is at least 1/100 (0.01) that of the MFR of the solid polymer particles prior to heat treatment. That is, according to the process of the invention, the final MFR of the heat-treated solid polymer particles will be less than or equal to 1/100 of the MFR of either the melt-mixed polymer blend or the MFR of the solid polymer particles prior to heat treatment. For example, final MFRs which are equal to 1/150 (0.007), 1/125 (0.008), or 1/110 (0.009) of the MFR of the solid polymer particles prior to heat treatment would meet this definition.

The process of the invention results in enhanced solid state polymerization rate. This enhanced rate may be expressed the following equation:

Polymerization rate=[ln(MFR(A))−ln(MFR(B))]/X hours (Eq. 2)
where MFR(A) is the melt flow rate of the starting polymer mixture of the melt-mixed blend of copolyester thermoplastic elastomer and polar polymer;
MFR(B) is the melt flow rate of the heat-treated solid polymer particles after undergoing solid state polymerization; and
ln is the natural log of the melt flow rate
X is the total polymerization time
Generally, the solid state polymerization process of the invention is conducted such that the heating step over a period of up to about 100 hours, preferably 24-72 hours.

As an example of the use of Equation 2, if the starting MFR(A) is 35 g/10 min. and the final MFR(B) is 0.2 g/10 min., and the reaction is conducted for 24 hours, then the polymerization rate is calculated as follows:

[ln 35−ln 0.2]/24=[3.55−(−1.61)]/24=5.16/24=0.215[ln(g/10 min.)]/hour.

Additional ingredients may be added to the heat-treated solid polymer particles prepared by the process of the invention that comprise the polyester resin composition product. Depending on the end use application, such additional ingredients include but are not limited to stabilizers, antioxidants, tougheners, pigments, plasticizers, lubricants, reinforcing agents, mold release agents, flame retardants, and other fillers. Suitable solid particulate fillers may be coated fillers. An example of a suitable filler coating is a sizing and/or other coating material that improves adhesion of the solid particulate filler to the polymers present in the composition. The solid particulate filler may be organic or inorganic. Useful solid particulate fillers include minerals such as clay, talc, wollastonite, mica, and calcium carbonate; glass in various forms such as fibers, milled glass, solid or hollow spheres; carbon, such as carbon black, carbon fiber, graphene sheets (exfoliated graphite, graphite oxide), carbon nanotubes or nano-diamond; titanium dioxide; aramid in the form of short fibers, fibrils or fibrids; and flame retardants such as antimony oxide, sodium antimonate, and appropriate infusible organic compounds.

The solid particulate material may be conventionally melt-mixed with the heat-treated solid polymer particles, for example in a twin-screw extruder or Buss kneader.

Articles comprising heat-treated solid polymer particles prepared in the SSP step of the process of the invention (i.e. the polyester resin composition product of the solid state polymerization step) may be prepared by any means known in the art, such as, but not limited to, methods of injection molding, extrusion, blow molding, thermoforming, solution casting, or film blowing. Such articles are particularly useful in molded parts, packaging, monofilament, and other applications in which engineering plastics are typically used.

The heat-treated solid polymer particles, i.e. the polyester resins, often including additional optional ingredients, are particularly useful for manufacture of “appearance parts”, that is parts in which the surface appearance is important. Such parts include automotive body panels such as fenders, fascia, hoods, tank flaps and other exterior parts; interior automotive panels; automotive lighting fixtures; parts for appliances (e.g., refrigerators, dishwashers, washing machines, clothes driers, food mixers, hair driers, coffee makers, toasters, and cameras), such as handles, control panels, chassis (cases), washing machine tubs and exterior parts, interior or exterior refrigerator panels, and dishwasher front or interior panels; power tool housings such as drills and saws; electronic cabinets and housings such as personal computer housings, printer housings, peripheral housings, server housings; exterior and interior panels for vehicles such as trains, tractors, lawn mower decks, trucks, snowmobiles, aircraft, and ships; decorative interior panels for buildings; furniture such as office and/or home chairs and tables; and telephones and other telephone equipment. As mentioned above, these parts may be painted or they may be left unpainted in the color of the composition.

Parts wherein surface appearance is not critical may also be combined with the “appearance parts”. Such parts include those made with so-called engineering thermoplastics, especially those which are filled with materials which are designed to enhance the physical properties of the composition, such as stiffness, toughness, and tensile strength. Examples include but are not limited to electrical connectors, covers for switchboxes or fuses, radiator grille supports, headlamp mountings, printed circuit boards, plugs, switches, keyboard components, small electric motor components, distributor caps, bobbins, coil-formers, rotors, windshield wiper arms, headlight mountings, other fittings, and conveyor-belt links.

The heat-treated solid polymer particles comprising the polyester resin prepared by the processes of the invention will find use in applications that involve some type of repeated mechanical movement, such as bending, flexing, pushing, rotating, pulsing, impacting, or recoiling, since they have a desirable combination of strength, toughness, flexibility and recovery from deformation. Examples of uses include but are not limited to hydraulic hosing, rail car couplers, release binders, auto vacuum control tubing, door lock bumpers, railroad car shock absorbers, headphones; specialty fibers, films, and sheets; jacketing, automotive shock absorbers, diaphragms for railroad cars, corrugated plastic tubing, railroad draft gear, auto electric window drive tapes, CVJ boots, recreational footwear, conductive rubbers, wire coatings, energy management devices, telephone handset cords, compression spring pads, wire clamps, gun holsters, drive belts, run-flat tire inserts, and medical films.

The invention is further illustrated by certain embodiments wherein all percentages are by weight unless otherwise indicated.

### EXAMPLES

### Materials

TPC-1—A polyetherester copolymer composed of 46 wt % polyester repeating units and 54 wt % polyether repeating units containing the specific groups listed in Table 2, having a melting temperature of 207° C., a Durometer Shore D hardness of 43, a flexural modulus of 77 MPa, and a melt flow rate (MFR) measured at 230° C. of 24 g/10 minutes under a 2.16 kg load.
PP-1—A polyether ester copolymer composed of 49 wt % polyester repeating units and 51 wt % polyether repeating units containing the specific groups listed in Table 2, having a Durometer Shore D hardness of 40, a melting temperature of 152° C., a flexural modulus of 60 MPa, and a MFR of 5.3 g/10 minutes at 190° C. under a 2.16 kg load.
PP-2—A polyether ester copolymer composed of 50 wt % polyester repeating units and 50 wt % polyether repeating units containing the specific groups listed in Table 2 and having a Durometer Shore D hardness of 32, a melting temperature of 132° C., a flexural modulus of 24 MPa, and a MFR of 14 g/10 minutes at 190° C. under a 2.16 kg load.
PP-3—a nylon multipolymer containing the specific groups listed in Table 2 and having a melting point of 156° C., a flexural modulus of 952 MPa, and a MFR of 2.2 g/10 min. at 190° C. under a 2.16 kg load, available from E. I. du Pont de Nemours and Company, Wilmington, Del., USA as ELVAMIDE™ 8061.
PP-4—an ethylene/methacrylic acid copolymer containing 11 wt % methacrylic acid having a melting point of 94° C., a flexural modulus of 87 MPa, and a MFR of 95 g/10 minutes at 190° C. under a 2.16 kg load, available from E. I. du Pont de Nemours and Company, Wilmington, Del., USA as NUCREL™ 699.
PM-1—1,4-butanediol having a solubility parameter of 24.8 (J/cm³)^{1/2}.

### Test Methods

### TPC-1, PP-1, PP-2,

### Hardness, Shore D: ISO 868

Flexural modulus: ISO 178
Melt Flow Rate: ISO 1133, 230° C., 2.16 kg load
Melting temperature: ISO 113357-1/-3, DSC 10° C./minute

### PP-3

Flexural modulus: ASTM D 790
Melt Flow Rate: ISO 1133, 230° C., 2.16 kg load
Melting temperature: ASTM D3418

### PP-4

Flexural modulus: ISO 178
Melt Flow Rate: ASTM D 1238, 190° C., 2.16 kg load
Melting point: ASTM D3418

The cohesive energy and molar volume of the groups in the repeating units of PP-1 to PP-4 are shown in Table 2 along with the total cohesive energy and total molar volume of each group within the repeating unit. These values are used to calculate solubility parameters of the materials in the examples and comparative examples. The cohesive energy and molar volume values were obtained from “Properties of Polymers” by D. W. van Krevelen and K. to Nijenhuis, fourth edition, 2009 or “Swelling Behavior and Solubility Parameter of Sulfonated Poly (ether ether ketone)” by H. L. Wu, et al., Journal of Polymer Science: Part B: Polymer Physics, Vol. 44, 3128-3134 (2006).

The number of repeating units of each group for the polymers in Table 2 is determined by the weight percentage of each monomer used in the polymerization to form the repeating unit. As an example of the calculation method, the calculation of the number of repeating units for PP-4 is calculated as follows:

The monomers used to prepare ethylene methacrylic acid copolymers are ethylene (molecular weight 28 g/mol) and methacrylic acid (molecular weight 86 g/mol). The weight percentage of ethylene in the polymer is 89% based on a total weight percent for the polymer of 100 wt % for all monomers used. Thus, the number of moles of ethylene and methacrylic acid are as:

89 g/28 g/mol=3.178 moles; 11 g/86 g/mol=0.128 moles;

The molar ratio of the monomers is 3.178:0.128=24.8 to 1 which is rounded to 25:1.

When polymerized, ethylene provides two —CH₂— units in the polymer chain for each polymerized monomer unit. Thus there are 25×2 or 50 —CH₂— units.

Methacrylic acid contains 1 —CH₂-unit and one of each of the units shown in Table 2 for a total —CH₂-unit count of 51.

TABLE 2

| | # repeating | | | Total Group | Group Total |
|---|---|---|---|---|---|
| | units | E_{coh (J/mol)} | V (cm³/mol) | E_{coh (J/mol)} | V (cm³/mol) |
| TPC-1 Group | | | | | |
| —C(O)—O— | 17 | 13410 | 23 | 227970 | 391 |
| —CH2— | 144 | 4150 | 15.85 | 597600 | 2282.4 |
| —(Ph)— | 9 | 30920 | 65.5 | 278280 | 589.5 |
| —C(O)— | 1 | 17890 | 13.4 | 17890 | 13.4 |
| —O— | 28 | 6830 | 10 | 191240 | 280 |
| TPC-1 | | | | 1312980 | 3556.3 |
| Repeating | | | | | |
| Unit Total | | | | | |
| PP-1 Group | | | | | |
| —C(O)—O— | 10 | 13410 | 23 | 134100 | 230 |
| —CH2— | 73 | 4150 | 15.85 | 302950 | 1157 |
| —(Ph)— | 6 | 30920 | 65.5 | 185520 | 393 |
| —C(O)— | 1 | 17890 | 13.4 | 17890 | 13.4 |
| —O— | 14 | 6830 | 10 | 95620 | 140 |
| PP-1 | — | — | — | 736080 | 1933 |
| Repeating | | | | | |
| Unit Total | | | | | |
| PP-2 Group | | | | | |
| —C(O)—O— | 11 | 13410 | 23 | 147510 | 253 |
| —CH2— | 74 | 4150 | 15.85 | 307100 | 1173 |
| —(Ph)— | 6 | 30920 | 65.5 | 185520 | 393 |
| —C(O)— | 1 | 17890 | 13.4 | 17890 | 13.4 |
| —O— | 14 | 6830 | 10 | 95620 | 140 |
| PM-2 | — | — | — | 753640 | 1972 |
| Repeating | | | | | |
| Unit Total | | | | | |
| PP-3 Group | | | | | |
| —C(O)—N(H)— | 10 | 60760 | 24.9 | 607600 | 249 |
| —CH2— | 54 | 4150 | 15.85 | 224100 | 856 |
| PP-3 | — | — | — | 831700 | 1105 |
| Repeating | | | | | |
| Unit Total | | | | | |
| PP-4 Group | | | | | |
| C(tetravalent) | 1 | (−5580) | 4.6 | (−5580) | 4.6 |
| —CH2— | 51 | 4150 | 15.85 | 211650 | 808 |
| —C00(H)— | 1 | 37580 | 18.25 | 37580 | 18.25 |
| —CH3 | 1 | 9640 | 23.9 | 9640 | 23.9 |
| PP-4 | — | — | — | 253290 | 855 |
| Repeating | | | | | |
| Unit Total | | | | | |

Values in parentheses are negative numbers

The group total values for E_{coh} (J/mol) and V (cm³/mol) from Table 2 are used in equation 1 to calculate the solubility parameter of the polar polymers. Table 3 shows the calculated solubility parameter values.

TABLE 3

| | Solubility Parameter (J/cm³)^{1/2} |
|---|---|
| TPC-1 | 19.21 |
| PP-1 | 19.51 |
| PP-2 | 19.55 |
| PP-3 | 27.43 |
| PP-4 | 17.21 |
| PM-1 | 24.8 |

As indicated above, melt flow rates were measured according to the method of International Standard ISO 1130 at a temperature of 230° C. under a 2.16 Kg load. The melt flow rates (A) shown in Table 4 are melt flow rates of the melt-mixed polymer mixture (the TPC and the polar polymer) and melt flow rates (B) are melt flow rates of the heat-treated solid polymer particles.

As indicated above, flexural modulus is measured using ISO 178. The test temperature was 23° C.

Melt-mix blending of the components listed in Table 4 for the Examples and Comparative Examples was conducted by combining and feeding the components to the rear of a ZSK 30 mm twin screw extruder (Coperion). The components were melt-mixed at a melt temperature of approximately 250° C., a screw speed of 75 rpm, and a throughput of 13.6 kg/h, to provide the melt mixed polymer mixture. After the compositions exited the extruder, they were passed through a die to form strands that were cooled and solidified in a quench tank and subsequently chopped to form solid particle particles. Ingredient quantities shown in Table 4 are in weight percent on the basis of the total weight of the polymer mixture.

### Example 1

The solid polymer particles prepared from the melt-mixing process described above were introduced into a double cone rotary reactor for the SSP step of the process. The reactor was purged with nitrogen and the reactor was then heated to 180° C. under a vacuum of 0.5 mbar. Polymerization was allowed to proceed for 24 hours. The reactor was cooled to room temperature while maintaining a vacuum. The heat-treated solid polymer particles were then removed from the reactor. The heat-treated solid polymer particles had a MFR of 0.11 g/10 minutes. The calculated reaction rate was 3/10 min./hour.

### Examples 2-5

Heat-treated resin compositions were prepared in the same manner as those of Example 1. Table 4 shows the quantity of polar polymers PP-1 to PP-4 and

PM-1 that were added to TPC-1. Values are given in parts per 100 parts total. Table 5 shows the starting and final MFR of the resins of Examples 1-5 and Comparative Examples C₁-C₄ and the calculated polymerization rate values.

The results in Table 4 clearly indicate that when polar polymers having melting temperatures or melting points that are at least 50° C. to 150° C. lower than those of the copolyester thermoplastic elastomer melting temperature or melting point and a solubility parameter greater than 18.4 (J/cm³)^{1/2} are added to a copolyester thermoplastic elastomer having a starting melt flow rate of between 20-50 g/10 minutes., that after SSP, the final melt flow rate is at least 1/100 (0.01) that of the melt flow rate of the blend of copolyester and polar polymer as shown by the MFR Ratio. Table 4 also shows that the polymerization rate of a copolyester thermoplastic elastomer is much faster when a polar polymer of the invention is blended with the copolyester thermoplastic elastomer than when the copolyester thermoplastic elastomer undergoes SPP without the presence of the polar polymer.

TABLE 4

| | Example | | | | | | | | |
|---|---|---|---|---|---|---|---|---|---|
| | 1 | 2 | 3 | 4 | 5 | C1 | C2 | C3 | C4 |
| TPC-1 | 99 | 99 | 99 | 97 | 95 | 100 | 99 | 97 | 99 |
| PP-1 | 1 | | | | | | | | |
| PP-2 | | | 1 | | | | | | |
| PP-3 | | 1 | | 3 | 5 | | | | |
| PP-4 | | | | | | | 1 | 3 | |
| PM-1 | | | | | | | | | 1 |
| Physical Properties | | | | | | | | | |
| Starting Melt Flow Rate (A) | 34.6 | 35.3 | 32.5 | 34 | 34 | 36.9 | 34 | 33.6 | 203 |
| (g/10 min.) | | | | | | | | | |
| Final Melt Flow Rate (B) | 0.11 | 0.07 | 0.17 | 0.12 | 0.10 | 0.44 | 4.00 | 4.10 | 2.1 |
| (g/10 min.) | | | | | | | | | |
| MFR Ratio (Final | 0.003 | 0.002 | 0.005 | 0.004 | 0.003 | 0.012 | 0.118 | 0.122 | 0.010 |
| MFR/Starting MFR) | | | | | | | | | |
| Polymerization Rate | | | | | | | | | |
| Calculation | | | | | | | | | |
| [In(MFR(A)) − In(MFR(B))]/ | 0.240 | 0.257 | 0.219 | 0.235 | 0.243 | 0.185 | 0.089 | 0.088 | 0.190 |
| 24 | | | | | | | | | |
| ([1n(g/10 min.)]/hour | | | | | | | | | |

Values for each component are parts per 100 parts total

What is claimed is:

1. A process for solid state polymerization of copolyester thermoplastic elastomers having i) a melt flow rate of from 20-50 g/10 minutes as determined according to ISO 1130 at 230° C. under a 2.16 kg load and ii) a melting temperature, the process comprising the steps of:
A. melt mixing
1. 90-99.5 wt % of a copolyester thermoplastic elastomer; and
2. 0.5-10 wt % of a polar polymer having a melting temperature in the range of 40° C. to 110° C. below the melting temperature of the copolyester thermoplastic elastomer, said polar polymer having a solubility parameter of greater than or equal to 18.4 (J/cm³)^{1/2}, to provide a melt-mixed polymer blend;
wherein the weight percentages of said copolyester thermoplastic elastomer and said polar polymer are based on the total weight of the copolyester thermoplastic elastomer and polar polymer;
B. forming solid polymer particles from the melt-mixed polymer blend;
C. heating the solid polymer particles under vacuum or an inert atmosphere to a temperature that is 5° C. to 50° C. below the melting temperature of the copolyester thermoplastic elastomer to provide heat-treated solid polymer particles comprising a copolyester resin composition, wherein the heat-treated solid polymer particles have a melt flow rate, as determined according to ISO 1130 at 230° C. under a 2.16 kg load which is less than or equal to 1/100 the melt flow rate of the melt-mixed polymer blend; and
D. cooling and collecting said heat-treated solid polymer particles.

2. A process for the solid state polymerization of copolyester thermoplastic elastomers having i) a melt flow rate as determined according to ISO 1130 at 230° C. under a 2.16 kg load of from 20-50 g/10 minutes and ii) a melting temperature, the process comprising the steps of:
A. melt mixing:
1. 90-99.5 wt % of a copolyester thermoplastic elastomer; and
2. 0.5-10 wt % of a polar polymer having a melting temperature in the range of 40° C. to 110° C. below the melting temperature of the copolyester thermoplastic elastomer, said polar polymer having solubility parameter of greater than or equal to 18.4 (J/cm³)^{1/2}, to provide a melt-mixed polymer blend;
wherein the weight percentages of said copolyester thermoplastic elastomer and said polar polymer are based on the total weight of the copolyester thermoplastic elastomer and polar polymer;
B. forming solid polymer particles from the melt-mixed polymer blend;
C. heating the solid polymer particles under vacuum or an inert atmosphere to a temperature that is 5° C. to 50° C. below the melting temperature of the copolyester thermoplastic elastomer, thereby resulting in a polymerization rate of greater than or equal to 0.2 [ln(g/10 min.)]/hour to provide heat-treated solid polymer particles; and
D. cooling and collecting the heat-treated solid polymer particles.

3. A process of claim 1 or 2 wherein the polar polymer is from 0.5-5 wt % of the melt-mixed polymer blend.

4. A process of claims 1 of 2 wherein the polar polymer is from 0.5-3.0 wt % of the melt-mixed polymer blend.

5. A process of claims 1 of 2 wherein the copolyester thermoplastic elastomer has a melting temperature or melting point in the range of about 160 to about 230° C.

6. A process of claim 1 or 2 wherein the solid polymer particles are tumbled during the heating step.

7. A process of claim 1 or 2 wherein the heating step C takes place over a period of from 1-100 hrs.

8. A process of claim 1 or 2 wherein the solid polymer particles are heated to a temperature that is 5° C. to 30° C. below the melting point of the copolyester thermoplastic elastomer.

9. A process of claim 1 or 2 wherein the polar polymer is a polyamide or polyetherester copolymer having a melt flow rate measured according to ISO1130 at 190° C. under a 2.16 kg load of from 1-30 g/10 min.

10. An article made from the heat-treated solid polymer particles prepared by the process of claim 1 or 2.

11. An article of claim 10 wherein the article is a hollow part selected from the group consisting of tubes; pipes; hoses; air ducts; CV boots used in auto drive shaft axle applications; propeller shaft joint boots; and other convoluted boots used to seal joint, linkages, and gears.
